(19) United States
(12) Patent Application Publication
(10) Pub. No.: US 2020/0373693 A1
(43) Pub. Date: Nov. 26, 2020

(54) ELECTRONIC DEVICE AND CONTROL METHOD THEREOF

(71) Applicant: Acer Incorporated, New Taipei City (TW)

(72) Inventors: Meng-Chieh TSAI, New Taipei City (TW); Chun-Chih KUO, New Taipei City (TW)

(21) Appl. No.: 16/559,991

(22) Filed: Sep. 4, 2019

(30) Foreign Application Priority Data
May 23, 2019 (TW) 108117797

(51) Int. Cl. H01R 12/55; H01R 12/52

(52) U.S. Cl. CPC H01R 12/55; H01R 12/52

(57) ABSTRACT

An electronic device including a connection port, a detection circuit, and a control circuit is provided. The detection circuit detects the voltage at the signal contact terminal of the connection port. In response to an adapter being inserted into the connection port and the voltage of the signal contact terminal being equal to a predetermined voltage, the control circuit directs the processing circuit to operate in a first mode. In response to the adapter being inserted into the connection port and the voltage of the signal contact terminal not being equal to the predetermined voltage, the control circuit directs the processing circuit to operate in a second mode. In the first mode, the operating power of the processing circuit is at a first power level. In the second mode, the operating power of the processing circuit is at a second power level higher than the first power level.

### CROSS REFERENCE TO RELATED APPLICATIONS

This Application claims priority of Taiwan Patent Application No. 108117797, filed on May 23, 2019, the entirety of which is incorporated by reference herein.

### BACKGROUND OF THE INVENTION

### Field of the Invention

The invention relates to an electronic device, and more particularly to an electronic device that is capable of coupling to an adapter.

### Description of the Related Art

With technological development, the types and functions of electronic devices have increased. When an adapter is inserted into an electronic device, the electronic device operates according to power provided from the adapter. However, if the adapter is not completely inserted into the electronic device, an impedance occurs between the adapter and the electronic device. Since the impedance is large, when the electronic device extracts a large current from the adapter, thermal energy is generated by the impedance. Furthermore, if the adapter is not completely inserted into the electronic device, when the electronic device is slightly moved by user, the adapter is easily to fall off. At this time, if the electronic device does not include a battery or the battery built into the electronic device does not have enough charges, the electronic device cannot operate normally. Additionally, when the adapter is not completely inserted into the electronic device, sparks are easily generated between the electronic device and the adapter.

### BRIEF SUMMARY OF THE INVENTION

In accordance with an embodiment, an electronic device comprises a connection port, a detection circuit, and a control circuit. The connection port comprises a signal contact terminal and a power contact terminal. The detection circuit detects the voltage of the signal contact terminal. The control circuit is coupled to the detection circuit and controls operating power of a processing circuit according to the voltage of the signal contact terminal. In response to an adapter being inserted into the connection port and the voltage of the signal contact terminal being equal to a predetermined voltage, the control circuit directs the processing circuit to operate in a first mode. In response to the adapter being inserted into the connection port and the voltage of the signal contact terminal not being equal to the predetermined voltage, the control circuit directs the processing circuit to operate in a second mode. In the first mode, the operating power of the processing circuit is at a first power level. In the second mode, the operating power of the processing circuit is at a second power level, which is higher than the first power level.

An exemplary embodiment of a control method for an electronic device comprising a connection port configured to couple to an adapter is described in the following paragraph. A voltage of a signal contact terminal of the connection port is detected. In response to the adapter being inserted into the connection port and the voltage of the signal contact terminal being equal to a predetermined voltage, a processing circuit is directed to operate in a first mode. In response to the adapter being inserted into the connection and the voltage of the signal contact terminal not being equal to the predetermined voltage, the processing circuit is directed to operate in a second mode. In the first mode, the processing circuit operates according to a first power level. In the second mode, the processing circuit operates according to a second power level, which is higher than the first power level.

The control method may be practiced by the electronic device which have hardware or firmware capable of performing particular functions and may take the form of program code embodied in a tangible media. When the program code is loaded into and executed by an electronic device, a processor, a computer or a machine, the electronic device, the processor, the computer or the machine becomes the electronic device for practicing the disclosed method.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an electronic device, according to various aspects of the present disclosure.

FIG. 2A is a side-view of an exemplary embodiment of a connection port according to various aspects of the present disclosure.

FIG. 2B is a schematic diagram of an exemplary embodiment of an adapter not being inserted into the connection port.

FIG. 2C is a schematic diagram of an exemplary embodiment of the adapter completely being inserted into the connection port.

FIG. 3 is a schematic diagram of an exemplary embodiment of a detection circuit, according to various aspects of the present disclosure.

FIG. 4 is a flowchart of an exemplary embodiment of a control method according to various aspects of the present disclosure.

FIG. 5 is a flowchart of another exemplary embodiment of the control method according to various aspects of the present disclosure.

FIG. 6 is a flowchart of another exemplary embodiment of the control method according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

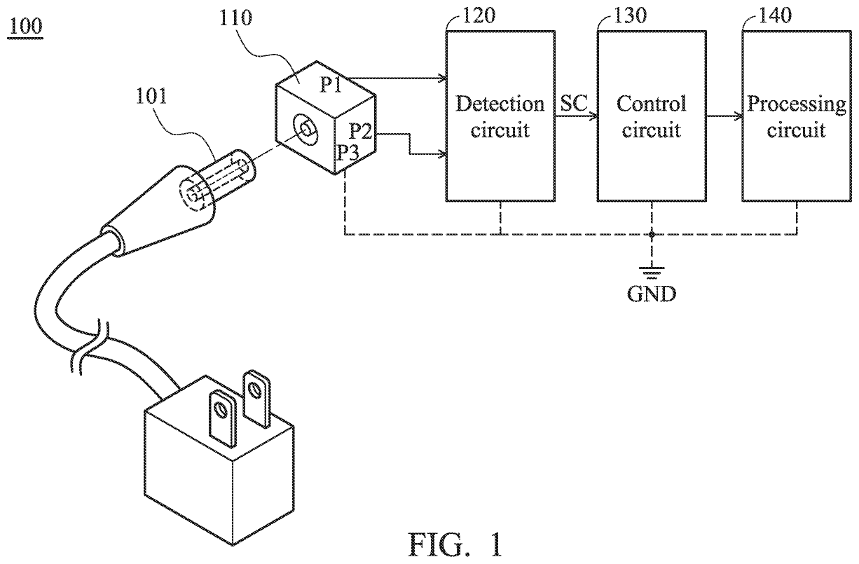

FIG. 1 is a schematic diagram of an exemplary embodiment of an electronic device, according to various aspects of the present disclosure. As shown in FIG. 1, the electronic device 100 comprises a connection port 110, a detection circuit 120, a control circuit 130 and a processing circuit 140. The kind of electronic device 100 is not limited in the present disclosure. In one embodiment, the electronic device 100 is a mobile electronic device, such as a notebook or a smart phone, but the disclosure is not limited thereto. In other embodiments, any electronic device serves as the electronic device 100, as long as the electronic device is capable of coupling to an adapter.

The connection port 110 comprises a power contact terminal P1 and a signal contact terminal P2. The power contact terminal P1 is configured to receive power from an adapter 101. The signal contact terminal P2 is configured to indicate whether the adapter 101 is inserted into the connection port 110. In other embodiments, the connection port 110 further comprises a ground contact terminal P3. The ground contact terminal P3 is configured to couple to the ground terminal of the adapter 101. In one embodiment, the ground contact terminal P3 of the connection port 110, the detection circuit 120, the control circuit 130 and the processing circuit 140 are coupled to a ground terminal GND together.

When the adapter 101 inserts into the connection port 110, the adapter 101 first contacts the ground contact terminal P3, then contacts the power contact terminal P1, and finally contacts the signal contact terminal P2. In one embodiment, when the adapter 101 does not contact the signal contact terminal P2, the voltage of the signal contact terminal P2 is equal to a predetermined voltage. When the adapter 101 contacts the signal contact terminal P2, the voltage of the signal contact terminal P2 is equal to the voltage of the ground contact terminal P3, such as 0V.

The detection circuit 120 detects the voltage of the signal contact terminal P2 to generate a control signal SC. In this embodiment, the detection circuit 120 further sets the voltage of the signal contact terminal P2 to a predetermined voltage. In one embodiment, when the voltage of the signal contact terminal P2 is equal to the predetermined voltage, it means that the adapter 101 is not inserted into the connection port 110 or the adapter 101 is not completely inserted into the connection port 110. Therefore, the detection circuit 120 does not assert the control signal SC. At this time, the control signal SC may be at a high level, but the disclosure is not limited thereto. In other embodiments, when the control signal SC is not asserted, the control signal SC is at a low level.

When the voltage of the signal contact terminal P2 is not equal to the predetermined voltage, it means that the adapter 101 is inserted into the connection port 110. Therefore, the detection circuit 120 asserts the control signal SC. At this time, the control signal SC may be at a low level, but the disclosure is not limited thereto. In other embodiments, when the control signal SC is asserted, the control signal SC is at a high level. The structure of detection circuit 120 is not limited in the present disclosure. Any circuit can serve as the detection circuit 120, as long as the circuit is capable setting and detecting the voltage of the signal contact terminal P2.

In other embodiments, the detection circuit 120 further detects the voltage of the power contact terminal P1. When the voltage of the power contact terminal P1 is equal to a target (e.g., 19V) and the voltage of the signal contact terminal P2 is equal to the predetermined voltage, it means that the adapter 101 is inserted into the connection port 110 but not fully inserted into the connection port 110. Therefore, the detection circuit 120 does not assert the control signal SC. However, when the voltage of the power contact terminal P1 is equal to the target voltage (e.g., 19V) and the voltage of the signal contact terminal P2 is not equal to the predetermined voltage, it means that the adapter 101 is fully inserted into the connection port 110. Therefore, the detection circuit 120 asserts the control signal SC.

The control circuit 130 is coupled to the detection circuit 120 and controls the processing circuit 140 according to the control signal SC. In this embodiment, since the control signal SC relates to the voltage of the signal contact terminal P2, the control circuit 130 controls the operation mode of the processing circuit 140 according to the voltage of the signal contact terminal P2. For example, when the voltage of the signal contact terminal P2 is equal to a predetermined voltage, it means that the adapter 101 is not inserted into the connection port 110 or the adapter 101 is not fully inserted into the connection port 110. Therefore, the control circuit 130 directs the processing circuit 140 to operate in a first mode. In the first mode, the processing circuit 140 operates according to a first power level.

However, when the voltage of the signal contact terminal P2 is not equal to the predetermined voltage, it means that the adapter 101 is fully inserted into the connection port 110. Therefore, the control circuit 130 directs the processing circuit 140 to operate in a second mode. In the second mode, the processing circuit 140 operates according to a second power level. In this embodiment, the second power level is higher than the first power level. In one embodiment, the second power level may be 100 W, and the first power level may be 15 W. In other embodiments, the first power level may be 0 W.

When the adapter 101 is inserted into the connection port 110 but not fully inserted into the connection port 110, since the current extracted from the adapter 101 by the processing circuit 140 is small, the sparks due to poor contact. In other embodiments, the processing circuit 140 does not extract current from the adapter 101. When the adapter 101 is completely inserted into the connection port 110, the processing circuit 140 extracts a large current from the adapter 101. Therefore, the processing circuit 140 has a high level of performance.

In other embodiments, the control circuit 130 controls the operation mode of the processing circuit 140 according to the voltage of the power contact terminal P1. For example, when the voltage of the power contact terminal P1 does not reach a target voltage, it means that the adapter 101 is not inserted into the connection port 110. Therefore, the control circuit 130 directs the processing circuit 140 to stop operating. When the voltage of the power contact terminal P1 reaches the target voltage but the voltage of the signal contact terminal P2 is equal to a predetermined voltage, it means that the connection port 110 is inserted into the connection port 110 but not fully inserted into the connection port 110. Therefore, the control circuit 130 directs the processing circuit 140 to operate in a first mode. When the voltage of the signal contact terminal P2 is not equal to the predetermined voltage, it means that the adapter 101 has been interest into the connection port 110. Therefore, the control circuit 130 directs the processing circuit 140 to operate in a second mode. In one embodiment, the detection circuit 120 detects the voltage of the power contact terminal P1. In other embodiments, the control circuit 130 detects the voltage of the power contact terminal P1.

The structure of the control circuit 130 is not limited in the present disclosure. In one embodiment, the control circuit 130 is an embedded controller (EC). In other embodiments, the processing circuit 140 adjusts an operation frequency according to the indication sent by the control circuit 130. For example, when the adapter 101 is not inserted into the connection port 110, the processing circuit 140 reduces the operation frequency. When the adapter 101 is inserted into the connection port 110, the processing circuit 140 increases the operation frequency. In another embodiment, the processing circuit 140 adjusts an operation voltage according to the indication sent by the control circuit 130. For example, when the adapter 101 is not fully inserted into the connection port 110, the processing circuit 140 reduces its operation voltage. When the adapter 101 is fully inserted into the connection port 110, the processing circuit 140 increases its operation voltage. In other embodiments, when the adapter 101 is not fully inserted into the connection port 110, the processing circuit 140 extracts a small current from the adapter 101. When the adapter 101 is fully inserted into the connection port 110, the processing circuit 140 extracts a large current from the adapter 101.

The structure of the processing circuit 140 is not limited in the present disclosure. In one embodiment, the processing circuit 140 is a central processing unit (CPU) or a graphics processing unit (GPU). In other embodiments, when the processing circuit 140 determines that the internal temperature of the electronic device 100 is higher than a threshold value, the processing circuit 140 operates in a third mode. In the third mode, the operating power of the processing circuit 140 is at a third power level. In this embodiment, the third power level is less than the second power level. In one embodiment, the third power level is about 40 W. After a period of time, is the internal temperature of the electronic device 100 is still higher than the threshold value, the processing circuit 140 operates in a fourth mode. In the fourth mode, the operating power of the processing circuit 140 is at a fourth power level. In one embodiment, the fourth power level may be 25 W and less than the third power level. In other embodiments, the electronic device 100 further comprises a temperature sensor (not shown) to detect the internal temperature of the electronic device 100. In this case, the control circuit 130 controls the operation mode of the processing circuit 140 according to the detection result generated by the temperature sensor.

In some embodiments, when the adapter 101 is not fully inserted into the connection port 110, the processing circuit 140 may stop operating. Therefore, the power of the processing circuit 140 may be equal to 0 W. When the adapter 101 is fully inserted into the connection port 110, the processing circuit 140 is at the maximum level of performance. However, when the internal temperature of the electronic device 100 is higher than the threshold value, the performance of the processing circuit 140 gradually suffers. In other embodiments, if the internal temperature of the processing circuit 140 is still higher than the threshold value, the processing circuit 140 may stop operating.

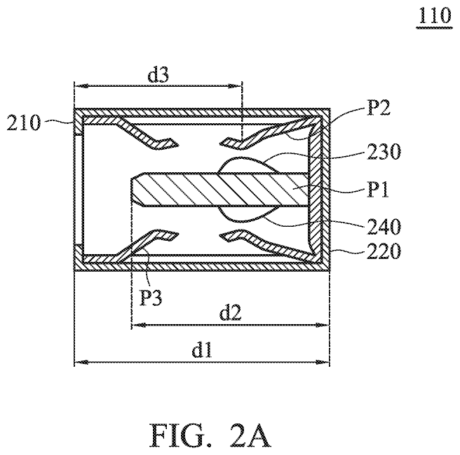

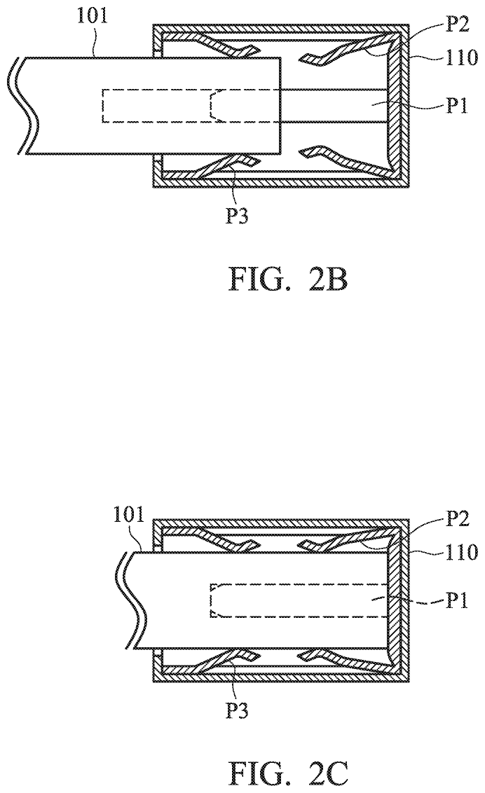

FIG. 2A is a side-view of an exemplary embodiment of a connection port according to various aspects of the present disclosure. As shown in FIG. 2A, a first side 210 of the connection port 110 has a hole configured to be inserted in by the adapter 101. In one embodiment, the ground contact terminal P3 of the connection port 110 is extended to the first side 210 such that the ground contact terminal P3 is first contacted by the adapter 101.

A second side 220 of the connection port 110 is opposite to the first side 210. In this embodiment, the distance d1 between the first side 210 and the second side 220 is about 6.45 mm. Additionally, the distance d2 between the second side 220 and the ground contact terminal P3 is about 4.9 mm. The distance d3 between the first side 210 and the signal contact terminal P2 is about 4.9 mm. In this embodiment, the power contact terminal P1 of the connection port 110 has prominent portions 230 and 240. The prominent portions 230 and 240 are configured to fix the adapter 101 to avoid the adapter 101 dropping off.

FIG. 2B is a schematic diagram of an exemplary embodiment of an adapter not being inserted into the connection port. In this embodiment, when the adapter 101 is not fully inserted into the connection port 110, since the signal contact terminal P2 does not be contacted by the adapter 101, the voltage of the signal contact terminal P2 is equal to a predetermined voltage.

FIG. 2C is a schematic diagram of an exemplary embodiment of the adapter 101 fully being inserted into the connection port 110. When the adapter 101 is inserted into the connection port 110, since the signal contact terminal P2 has been contacted by the adapter 101, the voltage of the signal contact terminal P2 is equal to the voltage of the ground contact terminal P3, such as 0V. In this embodiment, since the ground contact terminal P3 is extended to the first side 210, the adapter 101 first contacts the ground contact terminal P3, then contacts the power contact terminal P1, and finally contacts the signal contact terminal P2.

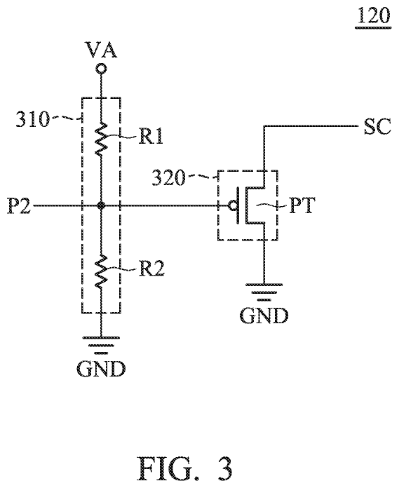

FIG. 3 is a schematic diagram of an exemplary embodiment of a detection circuit, according to various aspects of the present disclosure. As shown in FIG. 3, the detection circuit 120 comprises a voltage setting circuit 310 and a control element 320. The voltage setting circuit 310 is configured to set the voltage of the signal contact terminal P2 to a predetermined voltage. When the signal contact terminal P2 does not been contacted by an adapter, the voltage of the signal contact terminal P2 is equal to the predetermined voltage. The structure of the voltage setting circuit 310 is not limited in the present disclosure. Any circuit can serve as the voltage setting circuit 310, as long as the circuit is capable of setting the voltage of the signal contact terminal P2. In this embodiment, the voltage setting circuit 310 comprises resistors R1 and R2. The resistors R1 and R2 are serially connected between the power terminal VA and the ground terminal GND to divide the voltage of the power terminal VA. In this case, the divided voltage serves as the predetermined voltage.

The control element 320 is coupled to the signal contact terminal P2. When the voltage of the signal contact terminal P2 is equal to the predetermined voltage, the control element 320 does not assert the control signal SC. At this time, the control signal SC may be at a high level. When the voltage of the signal contact terminal P2 is not equal to the predetermined voltage, it means that the signal contact terminal P2 has been contacted by an adapter. The control element 320 asserts the control signal SC.

The kind of control element 320 is not limited in the present disclosure. In this embodiment, the control element 320 is a P-type transistor PT. As shown in FIG. 3, the gate of the P-type transistor PT is coupled to the signal contact terminal P2. The drain of the P-type transistor PT is coupled to the ground terminal GND. The source of the P-type transistor PT provides the control signal SC. In this case, when the voltage of the signal contact terminal P2 is equal to a predetermined voltage (e.g., 1.5V), the control element 320 does not be turned on. Therefore, the control signal SC is not asserted. When an adapter is inserted into the connection port, the voltage of the signal contact terminal P2 is not equal to the predetermined voltage. Assuming that the voltage of the signal contact terminal P2 is 0V. In this case, the control element 320 is turned on to assert the control signal SC.

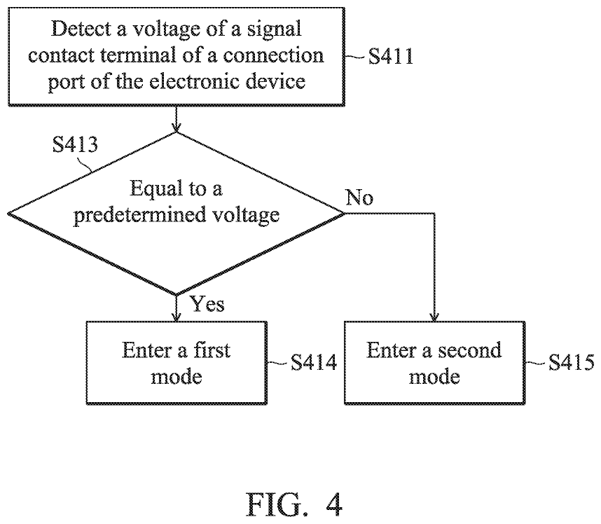

FIG. 4 is a flowchart of an exemplary embodiment of a control method according to various aspects of the present disclosure. The control method is applied in an electronic device to control the operation mode of the electronic device according to the connection state between the electronic device and an adapter. First, a voltage of a signal contact terminal of a connection port of the electronic device is detected (step S411). In one embodiment, the signal contact terminal is disposed in the innermost side of the connection port. When the adapter is fully plugged into the connection port, the signal contact terminal has been contacted by the adapter. In other embodiments, the connection port further comprises a ground contact terminal and a power contact terminal. When the adapter is plugged into the connection port, the adapter first contacts the ground contact terminal, then contacts the power contact terminal, and finally contacts the signal contact terminal.

A determination is made as to whether the voltage of the signal contact terminal is equal to a predetermined voltage (step S413). When the voltage of the signal contact terminal is equal to the predetermined voltage, it means that the adapter is not plugged into the connection port or the adapter is not fully plugged into the connection port. Therefore, a processing circuit is directed to enter a first mode (step S414). In the first mode, the processing circuit operates according to a first power level. In one embodiment, in the first mode, the processing circuit extracts a small current from the adapter. In other embodiments, in the first mode, the processing circuit does not extract current and stop operating.

When the voltage of the signal contact terminal is not equal to the predetermined voltage, it means that the adapter is fully plugged into the connection port. Therefore, the processing circuit is directed to enter a second mode (step S415). In the second mode, the processing circuit operates according to a second power level. The second power level is higher than the first power level. In one embodiment, the first power level is less than 10 W, and the second power level is equal to or higher than 100 W. In the second mode, the processing circuit extracts a large current from the adapter. Therefore, the processing circuit has large performance. In one embodiment, the processing circuit is a CPU or a GPU.

In one embodiment, a voltage setting circuit is disposed in the electronic device to initial the voltage of the signal contact terminal. When the adapter is not plugged into the connection port, the voltage setting circuit sets the voltage of the signal contact terminal to equal to a predetermined voltage. When the signal contact terminal has been contacted by the adapter, the voltage of the signal contact terminal may be changed from the predetermined voltage to a ground voltage.

In other embodiments, when the voltage of the signal contact terminal is not equal to the predetermined voltage, a control signal is asserted. However, when the voltage of the signal contact terminal is equal to the predetermined voltage, the control signal is un-asserted. In this case, a control circuit indicates the processing circuit to enter a corresponding mode according to the control signal. For example, when the control signal is asserted, the control circuit indicates the processing circuit to enter the second mode. Therefore, the processing circuit operates according to the second power level. When the control signal is un-asserted, the control circuit indicates the processing circuit to enter the first mode. In the first mode, the processing circuit operates according to the first power level. The control circuit may be an EC.

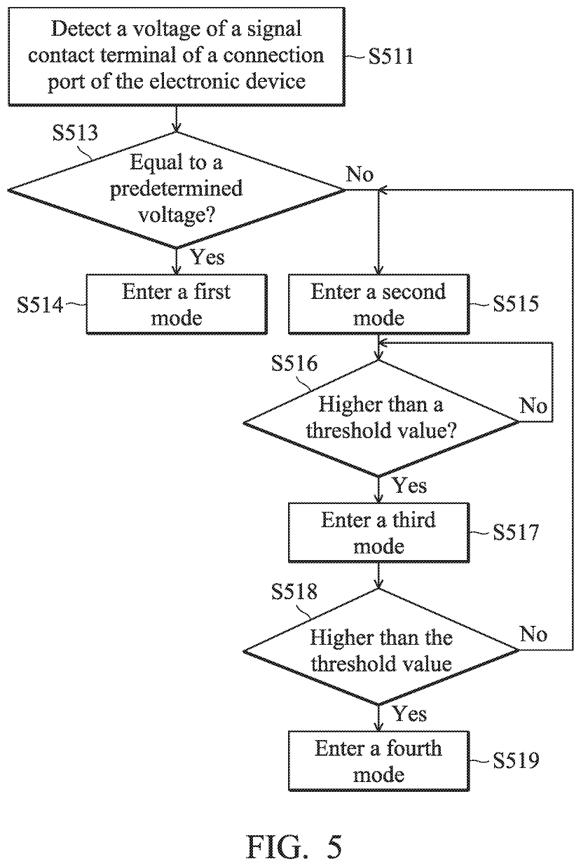

FIG. 5 is a flowchart of another exemplary embodiment of the control method according to various aspects of the present disclosure. FIG. 5 is similar to FIG. 4 except for the addition of steps S516-S519. Since the features of steps S511 and S513-S515 are the same as the features of steps S411 and S413-S415, the descriptions of the features of steps S511 and S513-S515 are omitted.

When the processing circuit enters the second mode, a determination is made as to whether the internal temperature of the electronic device is higher than a threshold value (step S516). In one embodiment, the processing circuit has a temperature sensor to detect the internal temperature of the electronic device. When the internal temperature of the electronic device is not higher than the threshold value, the processing circuit still operates in the second mode (step S515). When the internal temperature of the electronic device is higher than the threshold value, the processing circuit operates according to a third power level. The third power level is less than the second power level. For example, the third power level may be equal to 40 W. Since the operating power of the processing circuit is reduced, the internal temperature of the electronic device can be reduced.

Next, a determination is again made as to whether the internal temperature of the electronic device is still higher than the threshold value (step S518). When the internal temperature of the electronic device is not higher than the threshold value, the processing circuit is directed to enter the second mode (step S515). However, when the internal temperature of the electronic device is still higher than the threshold value, the processing circuit is directed to enter a fourth mode (step S519). In the fourth mode, the processing circuit operates according to a fourth power level. The fourth power level is less than the third power level. For example, the fourth power level may be 25 W. In other embodiments, if the internal temperature of the electronic device cannot be reduced, the processing circuit stops operating.

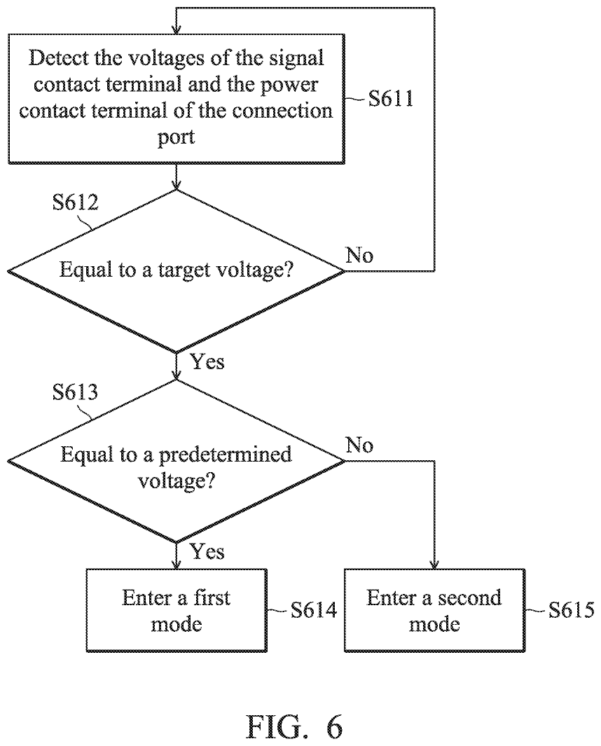

FIG. 6 is a flowchart of another exemplary embodiment of the control method according to various aspects of the present disclosure. Step 611 is to detect the voltages of the signal contact terminal and the power contact terminal of the connection port. Then, a determination is made as to whether the voltage of the power contact terminal is equal to a target voltage (step S612). When the voltage of the power contact terminal does not reach the target voltage, it means that the connection port is not plugged in by an adapter. Therefore, step S611 is performed again to detect the voltages of the signal contact terminal and the power contact terminal. When the voltage of the power contact terminal reaches the target voltage, it means that the connection port is plugged in by the adapter. Therefore, a determination is made as to whether the voltage of the signal contact terminal is equal to a predetermined voltage (step S613).

When the voltage of the signal contact terminal is equal to the predetermined voltage, it means that the adapter is not fully plugged into the connection port. Therefore, the processing circuit is directed to enter a first mode (step S611). However, when the voltage of the signal contact terminal is not equal to the predetermined voltage, it means that the adapter is fully plugged into the connection port. Therefore, the processing circuit is directed to enter a second mode (step S615). At this time, the voltage of the signal contact terminal may be equal to a ground voltage, such as 0V. Since the features of steps S614 and S615 are the same as the features of steps S414 and S415 of FIG. 4, the descriptions of the features of steps S614 and S615 are omitted.

Control methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an electronic devices for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes the electronic device for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

1. An electronic device, comprising:
a connection port comprising a signal contact terminal and a power contact terminal;
a detection circuit detecting a voltage of the signal contact terminal; and
a control circuit coupled to the detection circuit and controlling operating power of a processing circuit according to the voltage of the signal contact terminal,
wherein:
in response to an adapter being inserted into the connection port and the voltage of the signal contact terminal being equal to a predetermined voltage, the control circuit directs the processing circuit to operate in a first mode,
in response to the adapter being inserted into the connection port and the voltage of the signal contact terminal not being equal to the predetermined voltage, the control circuit directs the processing circuit to operate in a second mode, and
in the first mode, the operating power of the processing circuit is at first power level, and in the second mode, the operating power of the processing circuit is at a second power level, which is higher than the first power level, and
the detection circuit sets the voltage of the signal contact terminal to the predetermined voltage and then detects whether the voltage of the signal contact terminal is equal to the predetermined voltage.

2. The electronic device as claimed in claim 1, wherein the detection circuit further detects a voltage of the power contact terminal, and in response to the voltage of the power contact terminal being equal to a target voltage and the voltage of the signal contact terminal being equal to the predetermined voltage, the control circuit directs the processing circuit to operate in the first mode.

3. The electronic device as claimed in claim 2, wherein the connection port further comprises a ground contact terminal, and in response to the adapter being asserted into the connection port, the adapter first contacts the ground contact terminal, then contacts the power contact terminal and finally contacts the signal contact terminal.

4. The electronic device as claimed in claim 3, wherein in response to the adapter contacting the signal contact terminal, the voltage of the signal contact terminal is equal to a voltage of the ground contact terminal.

5. The electronic device as claimed in claim 4, wherein the detection circuit comprises:
a voltage setting circuit setting the voltage of the signal contact terminal to equal to the predetermined voltage in response to the adapter not contacting the signal contact terminal; and
a control element coupled to the signal contact terminal, wherein in response to the voltage of the signal contact terminal being equal to the predetermined voltage, the control element does not assert a control signal, and in response to the voltage of the signal contact terminal not being equal to the predetermined voltage, the control element asserts the control signal.

6. The electronic device as claimed in claim 5, wherein the control element is a P-type transistor.

7. The electronic device as claimed in claim 5, wherein in response to the control signal not being asserted, the control circuit directs the processing circuit to operate in the first mode, and in response to the control signal being asserted, the control circuit directs the processing circuit to operate in the second mode.

8. The electronic device as claimed in claim 5, wherein in response to a temperature of the processing circuit being higher than a threshold value, the processing circuit operates in a third mode, and in the third mode, the operating power of the processing circuit is at a third power level which is less than the second power level.

9. The electronic device as claimed in claim 1, wherein the control circuit is an embedded controller (EC).

10. The electronic device as claimed in claim 1, wherein the processing circuit is a central processing unit (CPU) or a graphics processing unit (GPU).

11. A control method for an electronic device comprising a connection port configured to couple to an adapter, comprising:
setting a voltage of a signal contact terminal of the connection port to a predetermined voltage;
detecting the voltage of the signal contact terminal of the connection port;
directing a processing circuit to operate in a first mode in response to the adapter being inserted into the connection port and the voltage of the signal contact terminal being equal to the predetermined voltage; and
directing the processing circuit to operate in a second mode in response to the adapter being inserted into the connection and the voltage of the signal contact terminal not being equal to the predetermined voltage,
wherein in the first mode, the processing circuit operates according to a first power level, and in the second mode, the processing circuit operates according to a second power level, which is higher than the first power level.

12. The control method as claimed in claim 11, further comprising:
detecting a voltage of a power contact terminal of the connection port, wherein in response to the voltage of the power contact terminal being equal to a target voltage and the voltage of the signal contact terminal being equal to the predetermined voltage, the processing circuit enters the first mode.

13. The control method as claimed in claim 12, wherein in response to the adapter being inserted into the connection port, the adapter first contacts a ground contact terminal of the connection port, then contacts the power contact terminal and finally contacts the signal contact terminal.

14. The control method as claimed in claim 13, wherein in response to the adapter contacting the signal contact terminal, the voltage of the signal contact terminal is equal to a voltage of the ground contact terminal.

15. The control method as claimed in claim 14, further comprising:
un-asserting a control signal in response to the voltage of the signal contact terminal being equal to the predetermined voltage; and
asserting the control signal in response to the voltage of the signal contact terminal not being equal to the predetermined voltage.

16. The control method as claimed in claim 15, wherein in response to the control signal not being asserted, the processing circuit is directed to enter the first mode, and in response to the control signal being asserted, the processing circuit is directed to enter the second mode.

17. The control method as claimed in claim 15, wherein in response to a temperature of the processing circuit being higher than a threshold value, the processing circuit is directed to enter a third mode, and in the third mode, the processing circuit operates according to a third power level, which is less than the second power level.
